(19) United States
(12) Patent Application Publication
(10) Pub. No.: US 2026/0269935 A1
(43) Pub. Date: Sep. 10, 2026

(54) PER LINK MOBILE SATELLITE BEAM DECONFLICTION

(71) Applicant: Viasat, Inc., Carlsbad, CA (US)

(72) Inventors: Nicholas G. BERNDSEN, Parker, CO (US); James E. PETRANOVICH, La Jolla, CA (US); Brian T. SLEIGHT, Carlsbad, CA (US); Michail K. TSATSANIS, Huntington Beach, CA (US); Anton HOFFMAN, San Diego, CA (US)

(21) Appl. No.: 19/164,952

(22) PCT Filed: Mar. 13, 2023
(86) PCT No.: PCT/US2023/015137

§ 371 Date: Sep. 12, 2025

(51) Int. Cl. H04B 7/185; H04B 7/06

(52) U.S. Cl. CPC H04B 7/18541; H04B 7/0617; H04B 7/18532

(57) ABSTRACT

Methods, systems, and devices for per link mobile satellite beam deconfliction are described. A communication service may be provided to mobile terminals via forward and return links of respective beamformed spot beams that track movement of the mobile terminals. When a conflict arises between the forward and/or return links of two or more beams, one of the conflicting forward or return links may be switched to a different resource element without changing the resource elements of the other forward and return links of the two or more beams, such that the communication service may continue to be provided to the associated mobile terminals via the forward and return links.

### CROSS REFERENCE

The present Application is a 371 national phase filing of International Patent Application No. PCT/US2023/015137 by BERNDSEN et al., entitled “PER LINK MOBILE SATELLITE BEAM DECONFLICTION,” filed Mar. 13, 2023, assigned to the assignee hereof, and expressly incorporated by reference in its entirety herein.

### FIELD OF TECHNOLOGY

The following relates generally to communications, including per link mobile satellite beam deconfliction.

### BACKGROUND

Communications devices may communicate with one another using wired connections, wireless (e.g., radio frequency (RF)) connections, or both. Wireless communications between devices may be performed using a wireless spectrum that has been designated for a service provider, wireless technology, or both. In some examples, the amount of information that can be communicated via a wireless communications network is based on an amount of wireless spectrum designated to the service provider, and an amount of frequency reuse within the region in which service is provided. Satellite communications may use beamforming to establish beams to increase frequency reuse, however, providing a high level of frequency reuse in satellite communication systems employing beamforming presents challenges.

### SUMMARY

The described techniques relate to improved methods, systems, devices, and apparatuses that support per link mobile satellite beam deconfliction. For example, a communication service may be provided to mobile terminals via forward and return links of respective beamformed spot beams as the beamformed spot beams track movement of the mobile terminals. When a conflict arises between the forward or return links of two or more beams, one of the conflicting forward or return links may be switched to a different resource element without changing the resource elements of the other forward and return links of the two or more beams, such that the communication service may continue to be provided to the associated mobile terminals via the forward and return links.

### BRIEF DESCRIPTION OF THE DRAWINGS

FIG. 1 shows an example of a satellite communication system that supports per link mobile satellite beam deconfliction in accordance with examples described herein.

FIGS. 2A and 2B show examples of resources for a satellite communication system that supports per link mobile satellite beam deconfliction in accordance with examples described herein.

FIG. 3 illustrates an example of a satellite communication system that supports per link mobile satellite beam deconfliction in accordance with examples as disclosed herein.

FIG. 4 illustrates an example of another satellite communication system that supports per link mobile satellite beam deconfliction in accordance with examples as disclosed herein.

FIGS. 5A and 5B illustrate example timing diagrams that support per link mobile satellite beam deconfliction in accordance with examples as disclosed herein.

FIG. 6 shows a block diagram of a beam manager that supports per link mobile satellite beam deconfliction in accordance with examples as disclosed herein.

FIG. 7 shows a block diagram of a terminal tracker that supports per link mobile satellite beam deconfliction in accordance with examples as disclosed herein.

FIG. 8 shows a flowchart illustrating a method that supports per link mobile satellite beam deconfliction in accordance with examples as disclosed herein.

### DETAILED DESCRIPTION

Beam handoff for terminals in a satellite communication system is typically performed at the same time for both forward and return links for a terminal. But forward links and return links often have different constraints and goals that could affect allocation and deconfliction decisions. By not considering the individual links, resource element allocation/reallocation may occur more often than necessary or not as often as needed. Either way, resources and/or time may be wasted when performing resource element allocation and beam deconfliction.

Techniques are described for allocating resource elements independently to forward and return links of spot beams and for making deconfliction decisions independently for forward and return link connections. Different resource elements may be used for forward and return links of a spot beam. Resource element allocation and deconfliction may be determined independently for the forward and return links of a beam. As such, forward link resource elements may be changed without changing return link resource elements and vice versa. Allocating resource elements independently based on the link type may deliver better service and more efficiently use limited satellite resources.

Aspects of the disclosure are initially described in the context of satellite communication systems. Aspects of the disclosure are further illustrated by and described with reference to apparatus diagrams, system diagrams, block diagrams, and flowcharts that relate to per link mobile satellite beam deconfliction.

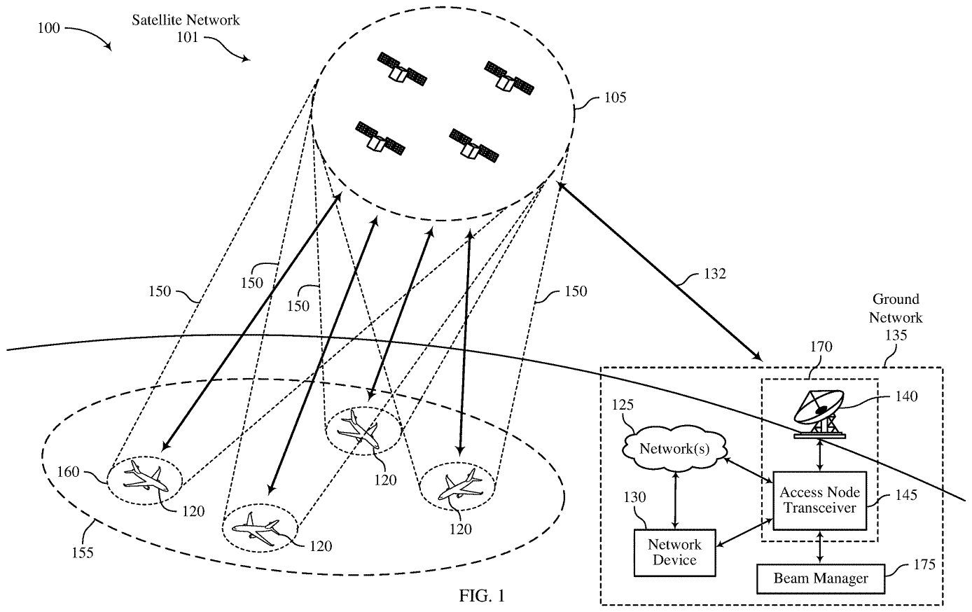

FIG. 1 shows an example of a satellite communication system 100 that supports per link mobile satellite beam deconfliction in accordance with examples described herein. Satellite communication system 100 may include a ground network 135 and a satellite network 101 configured to track and provide communication service to one or more mobile terminals 120.

The ground network 135 may include a collection of earth stations 170 having access nodes 140 configured to communicate with the satellite network 101 via a feeder link 132 (e.g., one or more satellite beams). The access nodes 140 may be coupled with access node transceivers 145 that are configured to process signals received from and to be transmitted through corresponding access node(s) 140. The access node transceivers 145 may also be configured to interface with a network 125 (e.g., the Internet)—e.g., via a network device 130 (e.g., a network operations center, satellite and gateway terminal command centers, or other central processing centers or devices) that may provide an interface for communicating with the network 125.

The ground network may also include a beam manager 175 for tracking mobile terminals 120 as communication service is provided to the terminals. Beam manager 175 may use reference-terminal associated beamformed spot beams, as discussed herein. For example, tracking of mobile terminals and performing deconfliction between associated beams, discussed herein may be controlled by beam manager 175 using the beams. Beam manager 175 may retrieve information (e.g., associated with the satellite network 101 and the terminals 120) from the satellite network 101 (e.g., via feeder link 132 and an access node 140) for performing the controlling, and may send commands (e.g., to the satellite network 101 and/or the terminals 120) accordingly (e.g., via the access node and feeder link).

Although depicted herein as a single device, beam manager 175 may alternatively be distributed throughout the system, e.g., in various elements of the satellite network and/or the ground network. For example, beam manager 175 may be incorporated into one or more devices of the ground network (e.g., a network device 130 or an access node transceiver 145), or one or more devices of the satellite network (e.g., in a single satellite 105 or distributed among multiple satellites), or a combination of devices in the ground network and the satellite network. In some embodiments, a first portion of beam manager 175 may be located in ground network 135 and a second portion may be located in satellite network 101.

Terminals 120 may include various devices configured to communicate signals with the satellite network 101. Although terminals 120 are illustrated as being on aircraft, terminals 120 may include fixed terminals (e.g., ground-based stationary terminals) or mobile terminals mounted on mobile platforms (e.g., boats, aircraft, ground-based vehicles, and the like), or a combination of fixed and mobile terminals. A terminal 120 may communicate data and information with an access node 140 via the satellite network 101. The data and information may be communicated with a destination device such as a network device 130, or some other device or distributed server associated with a network 125.

Satellite network 101 may include one or more satellites 105 (e.g., a single satellite or a network of satellites) that are deployed in space orbits (e.g., low earth orbits, medium earth orbits, geosynchronous orbits, geostationary orbits, etc.). Each satellite 105 included in satellite network 101 may be equipped with one or more antennas (e.g., a single antenna or an antenna array). In some examples, the one or more satellites 105 equipped with multiple antennas may each include one or more antenna panels that include an array of evenly distributed antennas (which may also be referred to as antenna elements). In some examples, a satellite may be equipped with an antenna array including antennas that are unevenly distributed across a large region. The ground network 135 may also contain access nodes 140 with multiple antenna array elements.

Terminals 120 may include an antenna assembly which may also include various hardware for mounting an antenna. An antenna assembly may also include circuits and/or processors for converting (e.g., performing frequency conversion, modulating/demodulating, multiplexing/demultiplexing, filtering, forwarding, etc.) between radio frequency (RF) satellite communication signals, and satellite terminal communications signals transmitted between the antenna and a satellite terminal receiver. For mobile terminals, the antenna assembly may be mounted on the outside of the mobile platform (e.g., outside of the fuselage of an aircraft). Additionally, or alternatively, the terminal 120 may include a transceiver, which may be mounted on the inside or outside of the mobile platform and may include circuits and/or processors for performing various RF signal operations (e.g., receiving, performing frequency conversion, modulating/demodulating, multiplexing/demultiplexing, etc.).

Beam manager 175 may use the one or more satellites to support beamforming techniques within the coverage area 155 of the satellite communication system to increase a utilization of resources used for communications. Beam manager 175 may employ beamforming, including using multiple-input multiple-output (MIMO) techniques, to exploit multipath signal propagation and increase spectral efficiency by transmitting or receiving multiple signals via different spatial layers over the same frequency resources. Beam manager 175 may cause multiple signals, for example, to be transmitted by a transmitting device (e.g., a satellite 105) via a set of antennas in accordance with a set of weighting coefficients. Likewise, the multiple signals may be received by a receiving device (e.g., a terminal 120) via a set of antennas in accordance with a set of weighting coefficients. Each of the multiple signals may be associated with a separate spatial stream and may carry bits associated with the same data stream (e.g., the same codeword) or different data streams (e.g., different codewords).

In some examples, some or all of the antenna elements on the satellites 105, the ground network 135, and/or the terminals 120 may be arranged as an array of constituent receive and/or transmit feed elements that cooperate to enable various examples of on-board beamforming (OBBF), ground-based beamforming (GBBF), end-to-end beamforming, or other types of beamforming. In the GBBF implementation, there may be multiple transmit or receive antennas on the ground system access node(s).

Beam manager 175 may determine weighting coefficients to apply to the set of antennas. For example, for N spatial layers to be formed, beam manager 175 may utilize an (Mx N) MIMO matrix, where M may represent the quantity of antennas of the set of antennas. In some examples, M may be equal to N. Beam manager 175 may determine the MIMO matrix based on a channel matrix and may use the MIMO matrix to isolate the different spatial layers of the channel. In some examples, beam manager 175 may select the weighting coefficients to emphasize signals transmitted using the different spatial layers while reducing interference of signals transmitted in the other spatial layers. Accordingly, processing signals received at each antenna of the set of antennas (e.g., a signal received at the set of antennas) using the MIMO matrix may result in multiple signals being output, where each of the multiple signals may correspond to one of the spatial layers. In some examples, the weighting coefficients used for MIMO communications may be referred to as beam coefficients or beamforming coefficients, and the multiple spatial layers may be referred to as beams or spot beams.

Beam manager 175 may determine the elements of the MIMO matrix used to form the spatial layers of the channel based on channel sounding probes. Channel sounding probes may include reference signals transmitted periodically between satellite network 101 and a device (e.g., a terminal 120) coupled with the satellite network. For example, a channel sounding probe may be periodically transmitted from a terminal 120 to a satellite 105 (e.g., via a return link), or from the satellite to the terminal (e.g., via a forward link), or both, and may include a sequence that is known to the transmitter and receiver (e.g., based on a terminal identifier or other parameters known to the transmitter and receiver). The receiving device (e.g., the terminal or the satellite) may use the received channel sounding probe to evaluate the connection by correlating the received channel sounding probe to the expected signal for the channel sounding probe (e.g., to determine a signal strength, an interference, etc.) and make decisions based thereon. Due to the periodicity of the signal, the receiving device may know when the signal should be received.

Beam manager 175 may use beamforming techniques to shape or steer a communication beam along a spatial path between one or more satellites and a mobile terminal 120 within a geographic area. Beam manager 175 may cause a communication beam to be formed by determining weighting coefficients for antenna elements of an antenna array that result in the signals transmitted from or received at the antenna elements being combined such that signals propagating in a particular orientation with respect to an antenna array experience constructive interference while others experience destructive interference. Thus, beamforming may be used to transmit signals having energy that is focused in a direction of a communication beam and to receive signals that arrive in a direction of the communication with increased signal power (relative to the absence of beamforming). Beam manager 175 may use the weighting coefficients to apply amplitude offsets, phase offsets, or both to signals carried via the antennas.

In some examples, beam manager 175 may apply the weighting coefficients to the antennas to form multiple beams, each associated with a different direction, where the multiple beams may be used to communicate multiple signals having the same frequency at the same time to different terminals (e.g., mobile terminals, ground stations). This may be referred to as Multiuser MIMO. The weighting coefficients used for beamforming may be referred to as beam coefficients, and the multiple signals may be referred to as beam signals. The resulting beams may be referred to herein as beamformed spot beams, spot beams, or beams.

Beam manager 175 may calculate the amplitude and phase of each weighting coefficient given the antenna array and reflector geometry and location and the desired beam locations. However, due to inaccuracies (e.g., in the satellite locations, array orientation, geometry, atmospheric scintillation effects, etc.), such an approach may be impractical. Instead, beam manager 175 may calculate the weighting coefficients using continuous or periodic measurements of the MIMO propagation channel characteristics (e.g., pairwise channels from each system antenna element to each terminal antenna element) and adjusting the weighting coefficients based on the changing channel characteristics. The measured MIMO channel characteristics may include pairwise gain and phase response and noise level and may be referred to as MIMO channel state information (CSI). Once the MIMO CSI is available, beam manager 175 may derive the weighting coefficients by solving a set of equations or applying a set of adaptation formulas. Various beamformer calculation and adaptation techniques may be used, including minimum mean square (MMSE) beamformer, zero forcing beamformer, MIMO sphere decoder, and others.

The measurement of MIMO CSI may include the collaboration of at least one terminal for each beam. The situation may be different for the forward link direction (from the satellites to the terminals) versus the return link direction (from the terminals to the satellites). In the return link, each terminal may transmit a channel probing signal that may be orthogonal to probing signals of the other terminals. The satellites may determine which channel probing signal is transmitted from each terminal and may process the signal to estimate the channel parameters of the channel corresponding to that terminal. As such, the MIMO CSI on the return link may be computed locally on the satellite side for terminals that transmit channel probing signals. In contrast, on the forward link, the satellites may transmit channel probing signals. Different antenna elements may transmit signals that are orthogonal to each other. Each terminal tasked to compute MIMO CSI may do so by processing the probing signal corresponding to each transmit antenna element. Further, each such terminal may transmit the MIMO CSI back to a satellite using a return link control channel.

The spot beams generated that way may be tailored to the MIMO CSI provided by the terminals and each beam may illuminate the direction of each such terminal. Each beam has a finite coverage area 160 (e.g., several km diameter) and may therefore illuminate additional terminals that may be in the vicinity of the CSI generating terminal. These additional terminals may not provide CSI, as this may unnecessarily increase the CSI reporting channel overhead. The terminal that is used to provide MIMO CSI per beam may be considered the reference terminal for that beam. In some examples, the coverage area 160 of a beam may be determined based on the wavelength of the carrier wave and the diameter of the aperture. The coverage area 160 may correspond, e.g., to a footprint where the power level of the beam is above a threshold, or where the power level drop-off away from the center of the beam is less than a threshold amount (e.g., 3 decibels (dB) or 6 dB). In some examples, the coverage area 160 may be based on a beam width of the beam.

In some examples, one or more aircraft-based terminals 120 may be sufficiently separated in distance from each other and from the other aircraft, so that beam manager 175 may use a separate beam for each of the one or more terminals. In some examples, two or more of the terminals 120 may be in close proximity (e.g., at an airport) such that beam manager 175 may illuminate the terminals by a same beam. In the former case, each terminal on an aircraft may be a reference terminal for its beam, while in the latter case, one of several terminals on aircraft may serve as a reference terminal for the beam.

As the mobile terminal 120 moves in the airspace, the MIMO CSI may change, causing the direction of the beam to change. Beam manager 175 may adjust the beam direction based on the changed MIMO CSI so that the reference terminal may remain at or near the center of the beam. Therefore, as the reference terminal moves, the beam may follow its movement, as further explained herein.

Beam manager 175 may associate the forward and return links of beamformed spot beams with a set of resources of the satellite communication system 100. The set of resources may include, e.g., frequency resources, time resources, and polarization resources. For example, a given frequency range for the satellite communication system 100 may comprise frequency resources or channels, and a given amount of time may comprise different recurring time slots. For example, beam manager 175 may use a frequency channel to carry a signal (e.g., a modulated signal carried in a forward link or a return link of a beamformed spot beam) on one of the recurring time slots. By doing this, forward links or return links of beamformed spot beams may overlap spatially without interfering if they are associated with different frequency/time resource combinations. In addition, beam manager 175 may use multiple polarizations such that two forward links or return links of beamformed spot beams may overlap spatially without interfering if they are associated with different polarizations. Thus, forward links or return links of beamformed spot beams may overlap spatially without interfering if they are associated with different combinations of the resources (e.g., frequency channel/time slot/polarization combinations). The different combinations may be known as resource elements that together form a set of resource elements that may be used by beam manager 175 for communicating signals over a link. Beam manager 175 may control the association of the links with the resource elements and when to assign and reassign the resource elements to the links, as discussed herein.

Although the discussion herein refers to resource elements being assigned to the forward and return links of the beamformed spot beams, it may alternatively be said that the forward and return links are assigned to the resource elements. These phrases may be considered to be synonymous herein. That is, a resource element being assigned to a forward or return link may be considered to be the same as the forward or return link being assigned to the resource element. Similarly, assigning a resource element to a forward or return link may be considered to be equivalent to assigning the forward or return link to the resource element.

As discussed herein, beam manager 175 may adjust the individual coverage areas or footprints of the beamformed spot beams (e.g., by adjusting the weighting coefficients) so as to track (e.g., move in concert with) the respective mobile terminals (e.g., reference terminals). This may allow communication service associated with a mobile terminal to be provided via a same beamformed spot beam as the mobile terminal moves through the coverage area of the satellite communication system. This may reduce the number of beam-to-beam handoffs of the mobile terminals, which may reduce performance degradation and communication disruptions that can result from beam-to-beam handoffs. For example, a beam-to-beam handoff may require the beam handing off the terminal to coordinate with the beam receiving the terminal, which may require communication spanning several communication layers to transfer terminal information between access points (e.g., gateways, gateway modems) serving the beams and to verify the transfer. This may result in performance degradation and communication disruptions between beams.

Conflicts may occasionally arise between beams as the beams track mobile terminals, such as when two movable beamformed spot beams overlap spatially while the corresponding forward or return links use a same resource element (e.g., the same frequency channel, time slot, polarization combination). But these conflicts may be resolved using deconfliction procedures discussed herein. For example, when such a conflict occurs (e.g., based on an interference metric between the links satisfying a threshold), beam manager 175 may cause one of the conflicting mobile terminals to change to a different resource element for communicating via a forward or return link. As a result, little or no performance degradation may result. And because the deconfliction may involve only a single link of the beam (e.g., without communication across access points serving different beams), communication disruption associated with handoff between beams may be avoided while still using the same resource element for the other link of the beam.

Further, as the reference terminals move, they may remain centrally positioned within the coverage areas of the beams. This may allow the SNR of the reference terminals to remain high so that overall communication speed and efficiency associated with the reference terminals may also be high.

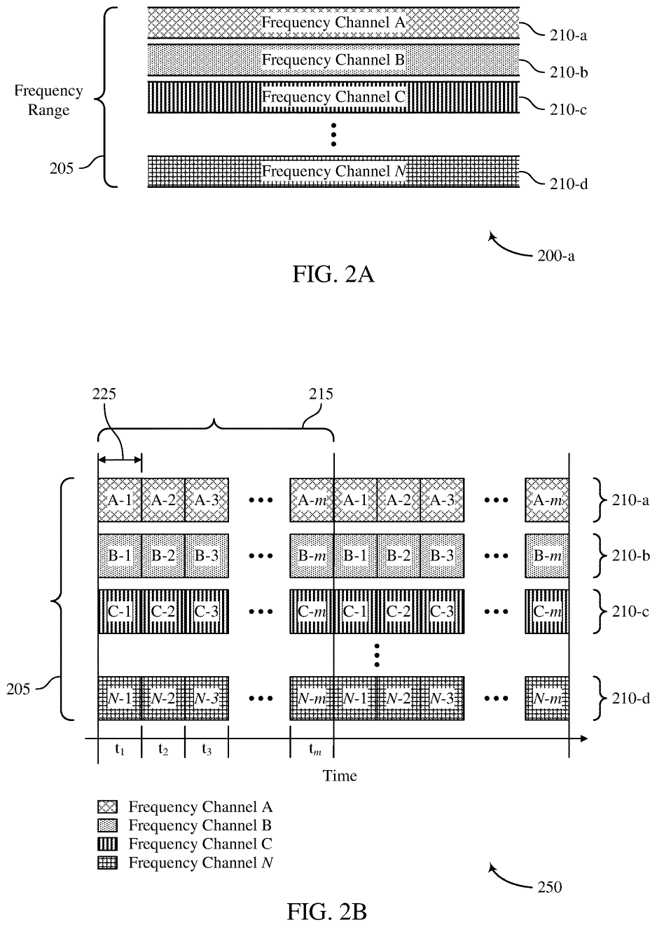

FIG. 2A shows an example of resources 200-a for a satellite communication system that support mobile satellite beam deconfliction in accordance with examples described herein. Resources 200-a may correspond to frequency divisions of a satellite communication system. For example, a frequency range 205 (e.g., a frequency band) may comprise a set of different frequency resources or frequency channels 210 (e.g., frequency channel 210-a, frequency channel 210-b, frequency channel 210-c, frequency channel 210-d) that carry signals between the satellite network and the terminals. The resources 200-a may correspond to the frequency channels 210 of the frequency range 205.

Each frequency channel 210 may carry signals associated with a single terminal (e.g., at a time). For example, each frequency channel 210 may carry a single modulated signal. Information (e.g., data, control information) may be modulated onto the modulated signal using a variety of single-carrier or multi-carrier modulation techniques (e.g., Orthogonal Frequency Division Multiplexing (OFDM), Direct Sequence Spread Spectrum (DSSS), linearly pre-coded OFDM (LP-OFDM)). The links of a beamformed spot beam may each be associated with one or more frequency channels 210 (e.g., by beam manager 175), for communication to be provided to a mobile terminal while the mobile terminal is being tracked, as discussed herein.

In the example of FIG. 2A, the resources 200-a may correspond to the frequency channels 210. That is, each frequency channel 210 may be a separate resource 200-a. As there are no other types of resources, the separate resources may also be resource elements in some examples. As such, in this example the number of available resource elements may correspond to the number of frequency channels, N.

FIG. 2B shows an example of resource elements 250 for a satellite communication system that support per link mobile satellite beam deconfliction in accordance with examples described herein. In this example, frequency channels 210 may again be used to carry signals associated with the terminals. In addition, the frequency channels 210 may be time multiplexed. That is, each frequency channel 210 may be configured to carry signals to and from the terminals in time slots that repeat after a period of time. For example, a time period 215 may be divided into a set of sub-periods or time slots t (e.g., time slot t₁, time slot t₂, time slot t₃, time slot tₘ) each having a length 225. Each frequency channel 210 may carry a signal to or from a different terminal (e.g., via forward or return links) during each time slot t, although in some cases multiple time slots within a time period 215 may be allocated to the same terminal. For example, each frequency channel 210 may carry a single modulated signal during each time slot t. Information (e.g., data, control information) may be modulated onto the modulated signal using a variety of single-carrier or multi-carrier modulation techniques (e.g., OFDM, DSSS, LP-OFDM) (e.g., by beam manager 175) for communication to be provided to a mobile terminal (e.g., via forward and return links) while the mobile terminal is being tracked, as discussed herein.

At the completion of the time period 215, the process may repeat such that each frequency channel 210 may carry further signals associated with the different terminals in a resource period. As a result, beam manager 175 may use the frequency channel 210 for communication with the terminal during one time slot t per time period 215. In some examples, beam manager 175 may assign more than one time slot per time period to a terminal, and thus communication with the terminal may occur over more than one time slot per time period for the frequency channel 210.

In the example of FIG. 2B, the resource elements 250 may correspond to the combinations of frequency channels 210 and time slots t in a time period 215. That is, each unique combination of frequency channel 210 and time slot t may be a separate resource element 250. As such, in this example the number of available resource elements may correspond to the number of frequency channels times the number of time slots, or N×m. Thus, this example may provide more resource elements than the example of FIG. 2A.

In addition to being multiplexed in time or frequency, different polarizations may be used to define the resource elements for assignment to beamformed spot beams. For example, a set of resource elements may include a first sub-set of resource elements associated with a first polarization and a second sub-set of resource elements associated with a second, orthogonal, polarization. The first and second polarizations may be orthogonal polarizations, and may be linearly polarized or circularly polarized (e.g., a right-hand circular polarization (RHCP), a left-hand circular polarization (LHCP)). Thus, a set of resource elements available to beam manager 175 for assignment to beamformed spot beams may be defined according to frequency resources (e.g., frequency channels), time resources (e.g., sub-periods of resource periods), or polarization resources.

In some examples, the types of resource elements may be combined. For example, in the same system, one or more frequency channels may be divided into time slots (e.g., as in FIG. 2B) and one or more other frequency channels may be used, undivided (e.g., as in FIG. 2A), as separate resource elements. Other combinations are also possible.

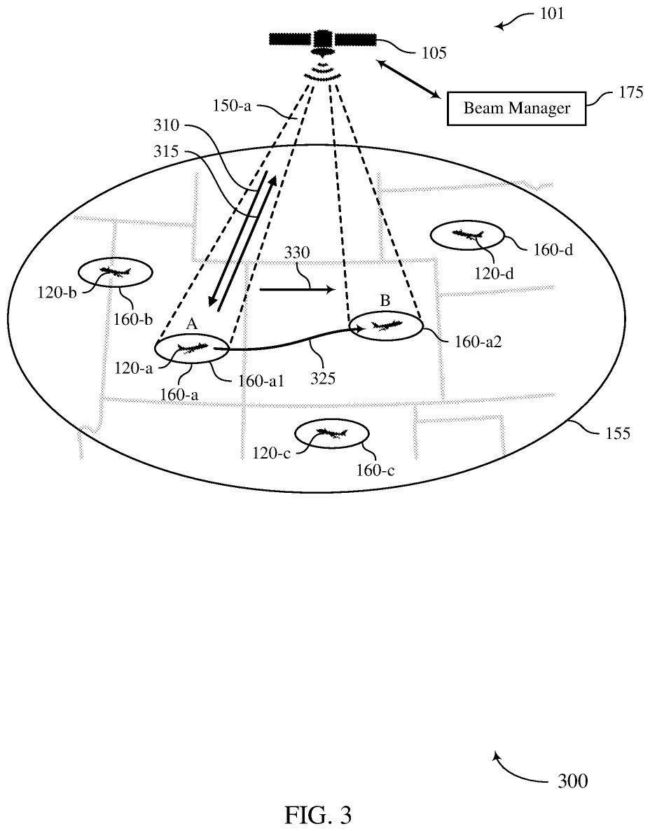

FIG. 3 illustrates an example of a satellite communication system 300 that supports per link mobile satellite beam deconfliction in accordance with examples as disclosed herein. The satellite communication system 300 may be an example of satellite communication system 100 as described with reference to FIG. 1 or aspects thereof. Satellite communication system 300 may include a satellite network 101 having one or more satellites 105 configured to generate beamformed spot beams 150 (e.g., beamformed spot beam 150-a) for communicating with a set of terminals 120 (e.g., terminals 120-a, 120-b, 120-c, 120-d) within a coverage area 155 of the satellite communication system, as directed by a beam manager 175. Beamformed spot beams may be referred to herein as spot beams or beams.

The terminals 120 may be located on movable platforms or vehicles, such as automobiles, boats, or aircraft, and thus may be considered to be mobile terminals 120. In some examples, each vehicle may include a single mobile terminal. In other examples, one or more vehicles may each include two or more mobile terminals. At least some of mobile terminals 120 may be multi-user mobile terminals, and thus the satellite communication system 300 may provide a communication service to multiple user devices (e.g., smartphones, laptops, tablets) connected via the mobile terminals 120.

In some examples, the satellite communication system 300 may provide communication service to the mobile terminals 120 via a set of movable beamformed spot beams 150 that track the mobile terminals, as controlled by beam manager 175, during movement of the mobile terminals. For the sake of clarity, only a single movable beamformed spot beam 150-a is illustrated in FIG. 3 associated with a single mobile terminal 120-a. Although not illustrated in FIG. 3, movable beamformed spot beams 150 may also be associated with one or more of the other mobile terminals 120.

In some examples, beam manager 175 may associate each beamformed spot beam 150 with a different mobile terminal 120. Each mobile terminal 120 associated with its own spot beam may be referred to as a reference terminal. Each beamformed spot beam 150 may have a respective coverage area 160 (e.g., coverage areas 160-a, 160-b, 160-c, 160-d). The coverage area may correspond, for example, to a footprint where the power level of the beam is above a threshold, or where the power level drop-off away from the center of the beam is less than a threshold amount (e.g., 3 dB or 6 dB).

In some examples, a beamformed spot beam associated with a reference terminal may be formed (e.g., as controlled by beam manager 175) to include the terminal's physical location within the coverage area of the beamformed spot beam. For example, as shown in FIG. 3, mobile terminal 120-a, acting as a reference terminal, may be physically located within the coverage area 160-a of beamformed spot beam 150-a and mobile terminals 120-b, 120-c, and 120-d may be physically located within the coverage areas 160-b, 160-c, and 160-d of their respective beamformed spot beams (not shown). The satellite communication system 300 may provide communication service to mobile terminals via links of the beams. For example, a forward link may be used for transmitting information to a mobile terminal and a return link may be used for receiving information from a mobile terminal associated with a beamformed spot beam. In the example of FIG. 3, a forward link 310 and a return link 315 of beamformed spot beam 150-a may be used to respectively transmit information to and receive information from mobile terminal 120-a via beamformed spot beam 150-a, as controlled by beam manager 175.

In some examples, beam manager 175 may cause a beamformed spot beam to track a moving mobile terminal while communication service is provided to the terminal via the beam. For example, as mobile terminal 120-a physically moves from location A to location B, as indicated by arrow 325, beamformed spot beam 150-a may “move” so as to track the mobile terminal, as indicated by arrow 330. In some examples, to “move” a beamformed spot beam, beam manager 175 may change and apply the beamforming coefficients associated with the beamformed spot beam to the signal associated with the beamformed spot beam. This may change the directionality of the beamformed spot beam (e.g., “move” the beam) so that the coverage area of the beamformed spot beam changes (e.g., “moves”).

To follow or track a mobile terminal, the beamforming coefficients may be changed by beam manager 175 such that the coverage area of the beamformed spot beam may move to reflect the movement of (e.g., may be moved in concert with) the mobile terminal. Beam manager 175 may continually adjust the coverage area (e.g., by periodically changing the beamforming coefficients to provide continuous coverage) to continue to correspond with the moving physical location of the moving mobile terminal and thereby track the mobile terminal. For example, beam manager 175 may move the coverage area 160-a of beamformed spot beam 150-a (e.g., from coverage area 160-a1 to coverage area 160-a2) so as to encompass the physical location of mobile terminal 120-a as mobile terminal 120-a moves from location A to location B. This may allow communication service associated with the mobile terminal to be provided via the same beamformed spot beam as the mobile terminal moves through the coverage area of the satellite communication system. For example, beam manager 175 may provide continuous communication service to mobile terminal 120-a via forward link 310 and return link 315 of beamformed spot beam 150-a without a handoff as the mobile terminal moves between location A and location B.

In some examples, beam manager 175 may refrain from changing the beamforming coefficients associated with a mobile terminal 120 while the mobile terminal is stationary because the coverage area 160 of the beamformed spot beam 150 may already correspond with the physical location of the stationary terminal. In other examples, beam manager 175 may change the beamforming coefficients even when a mobile terminal is stationary. For example, in some systems there may be a set of beamforming coefficients that may generate all of the beams from all of the beam signals. In those cases, even if only one terminal moves, beam manager 175 may change the beamforming coefficients used for all terminals.

In some examples, to track the mobile terminal 120, beam manager 175 may adjust the coverage area 160 of the spot beam (e.g., move the spot beam) based on measurements of signals communicated with the mobile terminal via the forward and return links. In some examples, the terminal 120 may provide channel state information back to satellite network 101 (e.g., via the return link) on a regular and periodic basis, and beam manager 175 may process this channel state information to compute appropriate beamforming coefficients such that the beam energy for the beam signal associated with an aircraft is focused on that aircraft. As the aircraft moves, the channel state information may change, which in turn may induce changes in the beam weight coefficients computed by beam manager 175. Through this beamformer adaptation process, the beam center may be co-located with the aircraft location continuously (may follow the aircraft).

Alternatively, beam manager 175 may use an initial estimate of where to move the beam based on the latest speed and direction of travel of the mobile terminal. In some examples, beam manager 175 may move the spot beam in such a manner that as the mobile terminal moves, the mobile terminal may remain centrally positioned within the coverage area. This may allow the SNR of the mobile terminal to remain high so that overall communication speed and spectral efficiency associated with the mobile terminal may also be high.

In some examples, beam manager 175 may determine the position of the mobile terminal based on information received from the mobile terminal, such as location coordinates (e.g., determined via a positioning system such as GPS), a speed, a direction or other information associated with the mobile terminal. This information may be received from the mobile terminal via a return link. In some examples, beam manager 175 may determine the position of the mobile terminal based on information external to the mobile terminal, such as based on radar or other signals.

In some examples, the satellite communication system may provide the communication service to one or more mobile terminals via beamformed spot beams associated with the terminals. For example, in FIG. 3, beam manager 175 may establish beamformed spot beams 150 for each of mobile terminals 120-a, 120-b, 120-c, and 120-d, and may provide the communication service to the terminals and track the mobile terminals as the mobile terminals move within the coverage area 155 of the satellite communication system.

In some examples, beam manager 175 may use initial channel state information to determine the locations of the mobile terminals. Beam manager 175 may determine the initial channel state information based on measurements (e.g., signal strengths) of initial signals communicated with (e.g., transmitted to or received from) the mobile terminals (e.g., using the forward and/or return links). The initial channel state information may be based on respective first locations (e.g., location A for mobile terminal 120-a) of the mobile terminals within the coverage area 155. In some examples, the initial signals may include respective initial channel sounding probes communicated with the mobile terminals (e.g., via the forward links) and/or by the mobile terminals (e.g., via the return links).

In some examples, to generate the beamformed spot beams, beam manager 175 may apply beamforming coefficients to convert between beam signals associated with each of the beamformed spot beams and component signals associated with a plurality of antenna elements of the satellite communication system. For example, to generate a forward link for transmitting information to a mobile terminal, beam manager 175 may apply beamforming coefficients to beam signals (that contain the information) to obtain component signals that may be applied to the antenna elements; and to generate a return link for receiving information from a mobile terminal, beam manager 175 may apply beamforming coefficients to component signals received from the mobile terminal at the antenna elements to obtain beam signals that contain the information.

The plurality of antenna elements may be positioned on one or more of the satellites 105 or may be positioned on components of a ground network (not shown) of the satellite communication system 300 (e.g., access nodes 140 of ground network 135 as shown in FIG. 1). Beam manager 175 may use the beamforming coefficients to form the beamformed spot beams 150 between the satellites 105 and the coverage areas 160. Beam manager 175 may base the beamforming coefficients on the initial channel state information so that the coverage areas 160 of the beam formed spot beams 150 may encompass the respective first locations (e.g., location A) of the associated terminals 120.

In some examples, the beamforming coefficients may include a plurality of sets of forward-link beamforming coefficients and a plurality of sets of return-link beamforming coefficients.

Beam manager 175 may apply a first set of the forward-link beamforming coefficients at a first time to a set of forward-link beam signals to generate a first set of forward-link component signals for transmission to one or more mobile terminals via the antenna elements at the first time. Transmission of the first set of forward-link component signals to the mobile terminals via the antenna elements may form forward-link beamformed spot beams, each corresponding to one of the mobile terminals for the first time.

Beam manager 175 may apply a second set of the forward-link beamforming coefficients at a second time to the set of forward-link beam signals to generate a second set of forward-link component signals for transmission to the mobile terminals via the antenna elements at the second time. Transmission of the second set of forward-link component signals to the mobile terminals via the antenna elements may form forward links of the beamformed spot beams, each corresponding to the mobile terminals for the second time. One or more of the beamformed spot beams at the second time may have moved from the corresponding beamformed spot beams at the first time to track movement of corresponding mobile terminals.

On the return link, beam manager 175 may apply a first set of the return-link beamforming coefficients at a first time to return-link component signals received from the mobile terminals via the antenna elements at the first time. Applying the first set of the return-link beamforming coefficients may form return links of the beamformed spot beams, each corresponding to one of the mobile terminals, for the first time.

Beam manager 175 may apply a second set of the return-link beamforming coefficients at a second time to return-link component signals received from the mobile terminals via the plurality of antenna elements at the second time. Applying the second set of the return-link beamforming coefficients may form return links of the beamformed spot beams for the second time. One or more of the beamformed spot beams at the second time may have moved from the corresponding beamformed spot beams at the first time to track movement of the corresponding mobile terminals.

In some examples, beam manager 175 may use subsequent channel state information to determine subsequent locations of the mobile terminals. Beam manager 175 may determine the subsequent channel state information based on measurements (e.g., signal strengths) of subsequent signals communicated with the mobile terminals (e.g., using the forward and/or return links). The subsequent channel state information may be based on respective second locations (e.g., location B for mobile terminal 120-a) of the mobile terminals within the coverage area 155. Differences between the initial channel state information and the subsequent channel state information may be based on movement of the mobile terminals to the respective second locations.

In some examples, the subsequent signals may include respective subsequent channel sounding probes communicated with the mobile terminals (e.g., via the forward links) and/or by the mobile terminals (e.g., via the return links). The revisions made to the beamforming coefficients may be based on the respective subsequent channel sounding probes. In some examples, the respective initial and subsequent channel sounding probes may be communicated with the mobile terminals at a first periodicity and the beamforming coefficients may be updated at a second periodicity based thereon.

In some examples, beam manager 175 may revise the beamforming coefficients and apply them to convert between the beam signals and the component signals associated with the plurality of antenna elements of the satellite network. The revised beamforming coefficients may be based on the subsequent channel state information so that the new coverage areas (e.g., coverage area 160-a2) of the beams may encompass the respective second locations (e.g., location B) of the mobile terminals.

The determination of subsequent locations of the mobile terminals and the revisions of the beamforming coefficients based thereon may be repeated by beam manager 175 as often and as long as desired. In this manner, the plurality of beamformed spot beams 150 may track movement of the reference terminals 120 throughout the coverage area 155 of the satellite communication system while communication service is provided to the terminals via the forward and return links. In some examples, beam manager 175 may move a beamformed spot beam 150 to track its respective mobile terminal sufficiently often such that the associated coverage area at a current location may overlap the coverage area at the prior location. That is, each movement of the beamformed spot beam 150 may move the beam less than a diameter (e.g., or the radius, or a fraction such as one half of the radius) of the beamformed spot beam 150.

In some examples, the beamforming coefficients (e.g., initial beamforming coefficients and the revised beamforming coefficients) may include sets of beamforming coefficients. Each set of beamforming coefficients may correspond to a different time period for the set of beamformed spot beams. In some examples, the beamforming coefficients may be revised based on a characteristic, attribute, or condition satisfying (e.g., meeting, exceeding, and/or falling below) a threshold. For example, beam manager 175 may revise and apply beamforming coefficients based on a received signal quality (e.g., a signal quality of the forward link measured at the reference terminal or a signal quality of the return link measured at the satellite communication system) falling below a threshold. This may allow the signal quality associated with the mobile terminal to remain high so that overall communication speed and efficiency associated with the mobile terminal may also be high. In some examples, beam manager 175 may determine the received signal quality based on the subsequent channel state information.

In some examples, beam manager 175 may cause the forward link and the return link of a beam to use different resource elements for providing communication services to the mobile terminal while tracking the mobile terminal. For example, the forward link of a beam may use a different combination of frequency channels, time slot, and polarization than the return link of the beam.

In some examples, beam manager 175 may cause the forward links or the return links of two or more beams to use different resource elements for providing communication services to respective mobile terminals while tracking the mobile terminals. For example, the forward link of a first beam may use a different combination of frequency channels, time slot, and polarization than the forward link of a second beam; or the return link of a first beam may use a different combination of frequency channels, time slot, and polarization than the return link of a second beam. By using different resource elements, interference between the forward links of separate beams or the return links of separate beams may be reduced or eliminated, even when the mobile terminals may be close to each other.

In some examples, beam manager 175 may cause the forward links or the return links of two or more beams to use a same resource element for providing communication services to the respective mobile terminals while tracking the mobile terminals. For example, the forward links of two or more beams may use a same combination of frequency channels, time slot, and polarization to send communication data to respective mobile terminals; or the return links of two or more beams may use a same combination of frequency channels, time slot, and polarization to receive communication data from respective mobile terminals. This may be desirable when the mobile terminals are far enough apart so that the forward links or the return links of the respective beams do not interfere with each other. By using the same resource elements, more beams may be used with a particular set of resources, thereby increasing frequency reuse.

In some examples, when two beamformed spot beams use a same resource element for the forward links or for the return links, beam manager 175 may cause the forward link or the return link of one of the beams to independently change to a different resource element, based on the interference between the forward links or the return links of the beams (e.g., an interference metric between the forward links or between the return links satisfying a threshold). As a result, per link beam deconfliction may be independently performed by beam manager 175. Further, because the forward link and the return link of a beam may use different resource elements, beam manager 175 may cause the forward link or the return link to continue to use its resource element even when beam manager 175 assigns a different resource element to the other link.

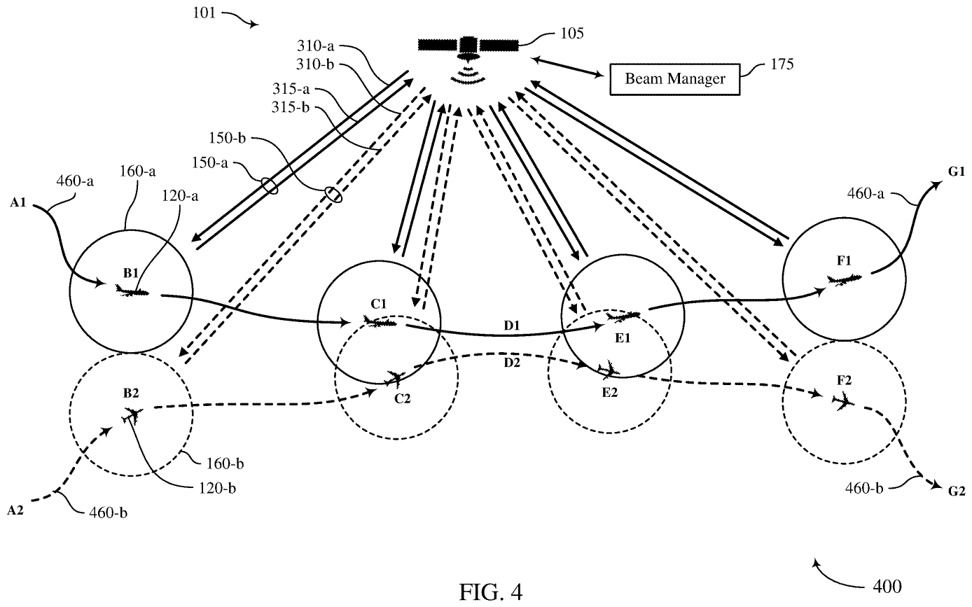

FIG. 4 illustrates another example of a satellite communication system 400 that supports per link mobile satellite beam deconfliction in accordance with examples as disclosed herein. The satellite communication system 400 may be an example of the satellite communication systems discussed herein, such as satellite communication systems 100 or 300 described with reference to FIG. 1 or FIG. 3 or aspects thereof.

Satellite communication system 400 may include a satellite network 101 having one or more satellites 105 configured to generate movable beamformed spot beams 150 (e.g., beamformed spot beam 150-a and 150-b) for communicating with mobile terminals 120 (e.g., mobile terminals 120-a and 120-b) as the beamformed spot beams track the mobile terminals. The beamformed spot beams 150 may each comprise a forward link 310 for transmitting information to the mobile terminals 120 and a return link 315 for receiving information from the mobile terminals 120. For example, beamformed spot beam 150-a may comprise forward link 310-a and return link 315-a and beamformed spot beam 150-b may comprise forward link 310-b and return link 315-b.

In some examples, each beamformed spot beam 150 may be associated with a different mobile terminal 120. For example, beam manager 175 may associate beamformed spot beam 150-a with mobile terminal 120-a (such that information may be sent to mobile terminal 120-a via forward link 310-a and information may be received from mobile terminal 120-a via return link 315-a), and beam manager 175 may associate beamformed spot beam 150-b with mobile terminal 120-b (such that information may be sent to mobile terminal 120-b via forward link 310-b and information may be received from mobile terminal 120-b via return link 315-b). The beamformed spot beams 150 may have coverage areas 160 (e.g., coverage areas 160-a and 160-b). For the sake of clarity, the moving beamformed spot beam 150-a and associated coverage area 160-a corresponding to moving mobile terminal 120-a are shown in solid lines, and the moving beamformed spot beam 150-b and corresponding coverage area 160-b corresponding to moving mobile terminal 120-b are shown in dashed lines.

FIG. 4 shows an example of two mobile terminals 120-a and 120-b passing close by each other as they travel along respective paths 460-a and 460-b. As with beamformed spot beam 150-b and corresponding coverage area 160-b, the path 460-b corresponding to mobile terminal 120-b is shown in dashed lines. The mobile terminals 120-a and 120-b may travel from respective start locations, represented by A1 and A2, to respective end locations, represented by G1 and G2, along paths 460-a and 460-b. Beamformed spot beam 150-a and 150-b are shown as being on aircraft, although other mobile platforms may also be used. Beamformed spot beam 150-a and 150-b may respectively track mobile terminals 120-a and 120-b (e.g., by beam manager 175 adjusting their respective coverage areas 160-a and 160-b in concert with the movement of the mobile terminals) while communication services are provided to the mobile terminals via the beams as the mobile terminals move along the paths.

As mobile terminals 120 move closer to each other, interference between the forward links or the return links of the associated beamformed spot beam 150 may increase (e.g., when the forward or return links or both of the beams use the same resource element. As discussed herein, beam manager 175 may cause one or more of the links to switch to different resource elements to ameliorate the interference.

At a point along the paths 460-a and 460-b, represented by B1 and B2, the beams may begin to overlap each other, e.g., by the mobile terminals moving toward each other. As used herein, beams may be considered to be overlapping based on the relative positions of the respective coverage areas of the beams. For example, beamformed spot beams 150-a and 150-b may be overlapping when their respective coverage areas 160-a and 160-b overlap each other. In some cases, the coverage area of a beam may be centered on the position of the mobile terminal that the beam is tracking. For example, coverage areas 160-a and 160-b may be centered on the position of mobile terminals 120-a and 120-b, respectively. In some examples, the overlapping of coverage areas may be based on a distance between the corresponding mobile terminals.

Further along the paths 460-a and 460-b, mobile terminals 120-a and 120-b may arrive at another point, represented by C1 and C2, at which one or more of the mobile terminals may enter into the coverage area of a beam that is not supporting (e.g., not providing communication service to or tracking) the mobile terminal (e.g., by the mobile terminals continuing to move toward each other). For example, at C1/C2, mobile terminal 120-a may enter into coverage area 160-b of beamformed spot beam 150-b, and/or mobile terminal 120-b may enter into coverage area 160-a of beamformed spot beam 150-a. At some point before or after this, interference between any of the links (e.g., the forward links 310-a and 310-b, the return links 315-a and 315-b) of beamformed spot beam 150-a and 150-b may rise to an unacceptable level. For example, an interference metric between the forward links or the return links may satisfy (e.g., meet; or exceed; or meet or exceed) a threshold value. Steps may be taken (e.g., by beam manager 175) to ameliorate the interference (e.g., deconflict the forward links or the return links of the beams), as discussed herein.

The mobile terminals 120-a and 120-b may each remain in the coverage areas 160-a and 160-b of both beamformed spot beam 150-a and 150-b until another point along the paths 460-a and 460-b, represented by E1 and E2. At that point, the mobile terminals may stop being in the coverage areas of the other's beam (e.g., by the mobile terminals moving away from each other). For example, at E1/E2, mobile terminal 120-a may stop being in the coverage area 160-b of beamformed spot beam 150-b and mobile terminal 120-b may stop being in the coverage area 160-a of beamformed spot beam 150-a. Even after the mobile terminals each stop being in the coverage area of the other terminal, the beams may still overlap. For example, at E1/E2, the coverage areas 160-a and 160-b of beamformed spot beam 150-a and 150-b may still overlap.

The beamformed spot beams 150-a and 150-b may remain overlapping until another point along the paths 460-a and 460-b, represented by F1 and F2. At that point, the beamformed spot beams 150-a and 150-b may stop overlapping each other (e.g., by the mobile terminals continuing to move away from each other). From that point to G1/G2 along the paths 460-a and 460-b, the beamformed spot beams 150-a and 150-b may remain apart and not overlapping, as long as the mobile terminals remain far enough apart from each other.

As discussed with respect to FIGS. 2A and 2B, beam manager 175 may use resource elements to provide communication service to mobile terminals via forward and return links of beamformed spot beams. In some examples, if the forward links of two beams do not conflict (e.g., the interference between the forward links is low), the forward links may use a same resource element for sending communication signals to the respective mobile terminals. For example, as long as respective interference metrics between forward links 310-a and 310-b of beamformed spot beams 150-a and 150-b remain below a threshold value, beam manager 175 may use the same resource element to provide communications to mobile terminals 120-a and 120-b via forward links 310-a and 310-b, as discussed herein.

In some examples, if the return links of two beams do not conflict (e.g., the interference between the return links is low), the return links may use a same resource element for receiving communication signals from the respective mobile terminals. For example, as long as respective interference metrics between return links 315-a and 315-b of beamformed spot beams 150-a and 150-b remain below a threshold value, beam manager 175 may use the same resource element to receive communication signals from mobile terminals 120-a and 120-b via return links 315-a and 315-b, as discussed herein.

In some examples, if a forward link of one beam and a return link of another beam do not conflict (e.g., the interference between the links is low), the links may use a same resource element for communicating signals to/from the respective mobile terminals. For example, as long as respective interference metrics between forward link 310-a and return link 315-b of beamformed spot beams 150-a and 150-b remain below a threshold value, beam manager 175 may use the same resource element to transmit communication signals to mobile terminal 120-a and receive communication signals from mobile terminal 120-b via forward link 310-a and return links 315-b, as discussed herein.

As the mobile terminals 120-a and 120-b move closer to each other (e.g., A1/A2 through B1/B2 and C1/C2 to D1/D2), interference between links of the corresponding beams may increase ( ) The increase in interference may mean that communication via the forward links and/or the return links of the separate beams is subject to too much inter-beam interference (e.g., when using the same resource element). When the interference rises to a level (e.g., the interference metric between the forward links and/or the return links of the beams satisfies a threshold value), steps may be taken by beam manager 175 to deconflict (e.g., ameliorate the interference between) the links, as discussed herein.

In some examples, the interference metric may correspond to a measured interference of the forward links and/or the return links of one or both of the beams. For example, the interference metric may correspond to a signal strength of a forward link or a return link of a beam associated with a first terminal measured at a second terminal. Additionally, or alternatively, the interference metric may correspond to the degradation of a beam's signal (e.g., a lower SNR) (e.g., associated with the forward link or the return link) and the threshold may correspond to a specific level of the metric or specific amount of degradation (e.g., 3 dB or 6 dB SNR loss). In some examples, the interference may be measured at the receiving device of the communication link. For example, the interference may be measured at the mobile terminals (for forward links) or the satellites (for return links).

In some examples, the interference metric may correspond to a channel correlation. For example, the interference metric may be based on a correlation between channel state information of the two mobile terminals. The interference metric may be frequency dependent.

In some examples, the interference metric may correspond to an estimated interference of one or both of the forward links or the return links. For example, the estimated interference may be based on the distance between the mobile terminals or on an algorithm that estimates the interference between the forward links or the return links of the associated beams. In some examples, the interference metric may be based on a distance between the mobile terminals associated with the beams and the threshold may correspond to a specific distance. For example, the threshold may correspond to the distance between mobile terminals at which the coverage areas of the corresponding beams begin to overlap (e.g., at B1/B2), or at which one of the mobile terminals enters into the coverage area of the beam corresponding to the other mobile terminal (e.g., at C1/C2), or somewhere in-between. Other distances are also possible.

In some examples, a single beam may be used to provide communication services to more than one mobile terminal. For example, beam manager 175 may assign one of the terminals to be a reference terminal for the beam to track while providing the communication services via the forward and return links. A reference terminal may be tasked with providing channel state information to beam manager 175 and may be representative of terminals in the same or similar location. The other terminals may also communicate via the beamformed spot beam that is produced via beamforming coefficients referenced to the reference terminal. This may be accomplished by sharing forward and return link resources between the mobile terminals. For example, via the same beam, communication service may be provided (e.g., by beam manager 175) to two or more of the mobile terminals on a same frequency channel, but in different time slots corresponding to the mobile terminals. In some examples, the same frequency channel and time slot may be used for the mobile terminals by further subdividing the time slot (e.g., into MAC layer frames) that may be addressed to the different users.

In some cases, unicast messages may be communicated with two or more mobile terminals via a same beam. For example, a first unicast message may be transmitted to a first mobile terminal and a second unicast message may be transmitted to a second mobile terminal via the same forward link of a shared beam. In some cases, multicast messages may be communicated with mobile terminals via a same beam. For example, a multicast message may be transmitted to the first and second mobile terminals via a same forward link of a same shared beam. In some cases, unicast messages and multicast messages may be communicated with the mobile terminals via different beams. In other cases, unicast messages and multicast messages may be communicated with the mobile terminals via the same beam. For example, in cases in which communication services are provided to more than one mobile terminal via a single beam (e.g., is shared by the mobile terminals), unicast messages may be communicated via the beam to each of the mobile terminals using different resources (e.g., different time slots) and multicast messages may be communicated via shared resources (e.g., using a shared time slot), or vice versa.

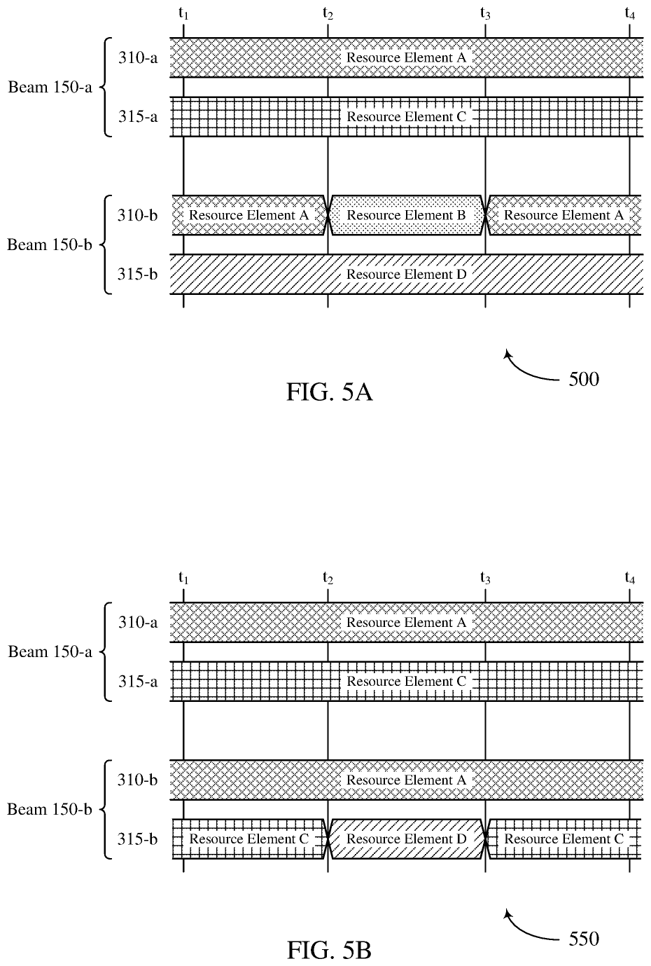

FIGS. 5A and 5B show example timing diagrams 500 and 550 that support per link mobile satellite beam deconfliction in accordance with examples as disclosed herein. Timing diagrams 500 and 550 represent the forward links 310 and return links 315 of beamformed spot beams 150-a and 150-b of FIG. 4 that may use different resource elements for providing communication services to mobile terminals 120-a and 120-b when interference rises between the links. As discussed with respect to FIGS. 3 and 4, a rise in interference may occur, e.g., when the mobile terminals get close to each other while the same resource element is being used by the forward links or the return links of the corresponding beams. As shown in timing diagrams 500 and 550, one of the forward links (e.g., forward link 310-b) or one of the return links (e.g., return link 315-b) may be switched to a different resource element (e.g., by beam manager 175) to ameliorate the interference.

Timing diagram 500 shows an example in which the forward links 310-a and 310-b of the beamformed spot beams 150 interfere with each other and timing diagram 550 shows an example in which the return links 315-a and 315-b of the beamformed spot beams 150 interfere with each other. For the sake of simplicity, the other links (i.e., the return links 315-a and 315-b in timing diagram 500 and the forward links 310-a and 310-b in timing diagram 550) are depicted as not interfering so that deconfliction of the forward links and the deconfliction of the return links may be independently discussed.

As shown in timing diagram 500, a same resource element A may be originally assigned to both forward links 310-a and 310-b and different resource elements C and D may be assigned to return links 315-a and 315-b (e.g., by beam manager 175). The original assignments may be performed at or before start time t₁, which may correspond to mobile terminals 120-a and 120-b being at A1/A2. As such, forward links 310-a and 310-b may both be using the same resource element A at start time t₁ for the satellite communication system to send communication information to respective mobile terminals 120-a and 120-b.

The mobile terminals may be a substantial distance from each other at start time t₁, such that beamformed spot beams 150-a and 150-b do not conflict with each other (e.g., there may be little, if any, interference between the forward links 310-a and 310-b, even though the same resource element A is assigned to them). As such, an interference metric between the forward links 310 may be relatively low (e.g., below a threshold value). In some examples, the same resource element A may be semi-statically assigned to forward links 310-a and 310-b (e.g., by beam manager 175), such that each terminal receives communication signals via the same resource element and monitors the received signals until the terminal receives an indication to switch its forward link to a different resource element.

At time t₂, the interference between forward links 310-a and 310-b may rise to an unacceptable level (e.g., the interference metric may satisfy a first threshold value). In some examples, this may correspond to when one of mobile terminals 120 enters into the coverage area of the other beamformed spot beam 150 (e.g., at or near C1/C2). In some examples, this may correspond to mobile terminals 120 being between B1/B2 and C1/C2. Other locations may also be possible, based on when the interference metric value satisfies the first threshold value. Some potential interference metrics and thresholds are discussed with respect to FIG. 4.

To ameliorate the interference, the forward link of one of the beams may be changed to a different resource element. For example, at time t₂, in response to the interference metric satisfying the first threshold value, beam manager 175 may cause forward link 310-b of beamformed spot beam 150-b to switch resource elements (e.g., by assigning a resource element B to forward link 310-b in place of resource element A) for the satellite communication system to transmit communication signals to mobile terminal 120-b. This may include changing one or more of the frequency channel, time slot, polarization, or other resource (e.g., one or more codes) associated with forward link 310-b to be different than that used by forward link 310-a. In some examples, resource element B may be orthogonal to resource element A.

Many factors may be used to determine which of the interfering spot beams to change to the different resource element. In some examples, the determination may be based on the priorities of the mobile terminals associated with the interfering beams. For example, the spot beam associated with the mobile terminal having the lowest priority among the conflicting mobile terminals may be changed to the different resource element. For example, the mobile terminal associated with beamformed spot beam 150-b may have a lower priority than the mobile terminal associated with beamformed spot beam 150-a.

In some examples, the determination may be based on the demands of the mobile terminals associated with the interfering beams. For example, the spot beam associated with the mobile terminal having the lowest demand among the conflicting mobile terminals may be changed to the different resource element. For example, the mobile terminal associated with beamformed spot beam 150-b may have a lower demand than the mobile terminal associated with beamformed spot beam 150-a. In other examples, the spot beam associated with the mobile terminal having the highest demand among the conflicting mobile terminals may be changed or not depending on the throughputs of the resource elements. For example, the mobile terminal associated with beamformed spot beam 150-b may have a higher demand than the mobile terminal associated with beamformed spot beam 150-a and resource element B may be associated with a higher throughput than resource element A.

In some examples, if no resource elements are available, the different resource element may be reassigned from another nearby terminal. For example, resource element B may be reassigned from a nearby terminal that may have a lower priority than the terminal associated with beamformed spot beam 150-b.

In some examples, resource element B may be the same as either of the resource elements in use by the return links 315-a or 315-b of the beams (e.g., resource element B may be the same as resource element C or resource element D). In some examples, resource element B may be different than resource elements C and D in use by the return links 315-a or 315-b.

Because communication signals may be transmitted to mobile terminals 120-a and 120-b via the forward links 310-a and 310-b using different resource elements than each other after time t₂, the interference between forward links 310-a and 310-b may be greatly reduced or no longer present. Thus, the satellite communication system may continue to transmit communication signals to mobile terminals 120-a and 120-b via forward links 310-a and 310-b without a beam-to-beam handoff being performed. Further, because the return links 315-a and 315-b may be using resource elements that are different than those used by the forward links 310-a and 310-b (e.g., resource elements C and D vs. resource elements A and B), the satellite communication system may also continue to receive communication signals from mobile terminals 120-a and 120-b, via return links 315-a and 315-b, without the resource elements of the return links being changed.

At time t₃, the forward links 310-a and 310-b of the beams may again use a same resource element as each other. For example, at time t₃, forward link 310-b may revert back to the original resource element (e.g., by beam manager 175 assigning resource element A back to forward link 310-b in place of resource element B) for transmitting communication signals to mobile terminal 120-b. Alternatively, forward links 310-a and 310-b may continue to use different resource elements than each other. For example, instead of changing the resource element of forward link 310-b back to resource element A, beam manager 175 may cause forward link 310-b to continue using resource element B after t₃.

Time t₃ may correspond to when an interference or a potential interference between forward links 310-a and 310-b may no longer be at an unacceptable level (e.g., an interference metric may not meet or exceed a second threshold value or may fall below a second threshold value). The interference metric may or may not be the same interference metric used at time t₂. Further, if the interference metric is the same as that used at time t₂, the second threshold value may be the same or different than the first threshold value used at time t₂. In some cases, time t₃ may correspond to when the mobile terminals are a certain distance from each other. Some potential interference metrics and thresholds are discussed with respect to FIG. 4.

After time t₃, as long as the interference metric between forward links 310-a and 310-b remains below a threshold value (e.g., the first threshold value or the second threshold value), the satellite communication system may continue to transmit communication signals to the mobile terminals via forward links 310-a and 310-b using the same resource element (e.g., resource element A), until at least time t₄. Time t₄ may correspond to mobile terminals 120-a and 120-b being at G1/G2. If, however, the interference between forward links 310-a and 310-b again rises to the level (e.g., the interference metric again satisfies the first threshold value), beam manager 175 may again cause the forward link (e.g., forward link 310-b) of one of the beams (e.g., beamformed spot beam 150-b) to switch to a different resource element than the other forward link and, in some examples, back again. This switching may be performed each time the interference between the forward links rises to the level. As a result, beam-to-beam handoffs and return link changes may be avoided.

As shown in timing diagram 550, a same resource element C may be originally assigned to both return links 315-a and 315-b and different resource elements A and B may be assigned to forward links 310-a and 310-b (e.g., by beam manager 175). As such, return links 315-a and 315-b may both be using the same resource element C at start time t₁ for the satellite communication system to receive communication signals from respective mobile terminals 120-a and 120-b.

At time t₁, beamformed spot beams 150-a and 150-b may not conflict with each other (e.g., there may be little, if any, interference between the return links 315-a and 315-b, even though the same resource element C is assigned to them). As such, an interference metric between the return links 315 may be relatively low (e.g., below a threshold value). In some examples, the same resource element C may be semi-statically assigned to return links 315-a and 315-b (e.g., by beam manager 175), such that each terminal transmits communication signals via the same resource element until the terminal receives an indication to switch its return link to a different resource element.

At time t₂, the interference between return links 315-a and 315-b may rise to an unacceptable level (e.g., the interference metric may satisfy a first threshold value). Some potential interference metrics and thresholds are discussed with respect to FIG. 4.

To ameliorate the interference, the return link of one of the beams may be changed to a different resource element. For example, at time t₂, in response to the interference metric satisfying the first threshold value, beam manager 175 may cause return link 315-b of beamformed spot beam 150-b to switch resource elements (e.g., by assigning a resource element D that is different than resource element C to return link 315-b) for the satellite communication system to receive communication signals from mobile terminal 120-b. In some examples, resource element D may be orthogonal to resource element C.

In some examples, resource element D may be the same as either of the resource elements in use by the forward links 310-a or 310-b of the beams (e.g., resource element D may be the same as resource element A or resource element B). In some examples, resource element D may be different than resource elements A and B in use by the forward links 310-a or 310-b.

Because communication signals may be received from mobile terminals 120-a and 120-b via the return links 315-a and 315-b using different resource elements than each other after time t₂, the interference between return links 315-a and 315-b may be greatly reduced or no longer present. Thus, the satellite communication system may continue to receive communication signals from mobile terminals 120-a and 120-b via return links 315-a and 315-b without a beam-to-beam handoff being performed. Further, because the forward links 310-a and 310-b may be using resource elements that are different than those used by the return links 315-a and 315-b (e.g., resource elements A and B vs. resource elements C and D), the satellite communication system may also continue to transmit communication signals to mobile terminals 120-a and 120-b, via forward links 310-a and 310-b, without the resource elements of the forward links being changed.

At time t₃, the return links 315-a and 315-b of the beams may again use a same resource element as each other. For example, at time t₃, return link 315-b may revert back to the original resource element (e.g., by beam manager 175 assigning resource element C back to return link 315-b in place of resource element D) for receiving communication signals from mobile terminal 120-b. Alternatively, the return links 315-a and 315-b may continue to use different resource elements than each other. For example, instead of changing the resource element of return link 315-b back to resource element C, beam manager 175 may cause return link 315-b to continue to using resource element D after time t₃.

Time t₃ may correspond to when an interference or potential interference between return links 315-a and 315-b may no longer be at an unacceptable level (e.g., an interference metric may not meet or exceed a second threshold value or may fall below a second threshold value). The interference metric may or may not be the same interference metric used at time t₂. Further, if the interference metric is the same as that used at time t₂, the second threshold value may be the same or different than the first threshold value used at time t₂. In addition, the interference metric and/or the interference metric values associated with the return links 315 may or may not be the same as those associated with the forward links 310.

After time t₃, as long as the interference metric between return links 315-a and 315-b remains below a threshold value (e.g., the first threshold value or the second threshold value), the satellite communication system may continue to receive communication signals from the mobile terminals via return links 315-a and 315-b using the same resource element (e.g., resource element C) until at least time t₄. If, however, the interference between return links 315-a and 315-b again rises to the level (e.g., the interference metric again satisfies the first threshold value), beam manager 175 may again cause the return link (e.g., return link 315-b) of one of the beams (e.g., beamformed spot beam 150-b) to switch to a different resource element than the other return link and, in some examples, back again. This switching may be performed each time the interference between the return links rises to the level. As a result, beam-to-beam handoffs and forward link changes may be avoided.

In some cases, due to different characteristics of forward links and return links (e.g., different frequencies, transmit vs. receive power/sensitivity, etc.), the times associated with the deconfliction procedures (e.g., times t₂ and t₃) may be at relatively different positions on the timing diagram 500 associated with a forward-link deconfliction than the timing diagram 550 associated with a return-link deconfliction.

The methods discussed with respect to timing diagrams 500 and 550 may be performed independently, as often as desired, to deconflict interfering forward links or interfering return links. In some cases, forward-link interference and return-link interference between beams may occur at the same time or around the same time. In those cases, the deconfliction of the forward links and the deconfliction of the return links may be caused to be performed (e.g., by beam manager 605) at the same time (e.g., at a same deconfliction cycle). Alternatively, deconfliction of the forward link may be caused to occur at a different time than deconfliction of the return link.

In some cases, link interference may involve more than two beams. For example, a first beam may have a forward link that interferes with a forward link of a second beam, and may have a return link that interferes with a return link of a third beam. In such cases, the deconfliction of the interfering forward links (between the first and second beams) and the deconfliction of the interfering return links (between the first and third beams) may be performed independently of each other.

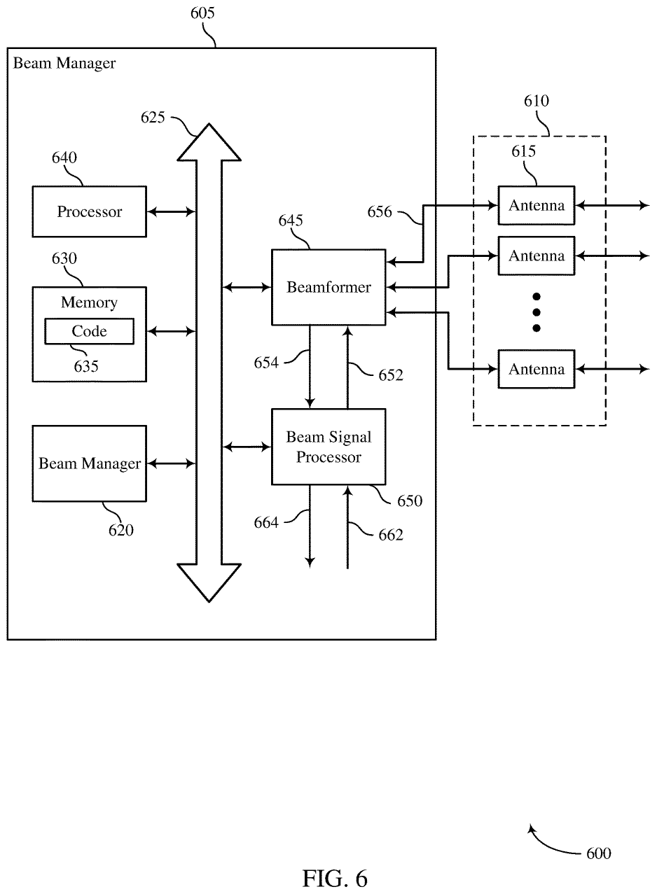

FIG. 6 shows a block diagram 600 of a beam manager 605 that supports per link mobile satellite beam deconfliction in accordance with examples as disclosed herein. Beam manager 605 may be an example of beam manager 175 of FIG. 1. Beam manager 605 may include a bus 625, a terminal tracker 620, a memory 630, code 635, a processor 640, a beamformer 645, and a beam signal processor 650, and may be configured to control beam tracking of mobile terminals and deconfliction of the beams via an antenna array 610.

Beam manager 605 may be located within the ground network (e.g., ground network 135 of FIG. 1) or the satellite network (e.g., satellite network 101 of FIG. 1) of the satellite communications system. Alternatively, beam manager 605 may be divided between the ground network and the satellite network. In one example (e.g., corresponding to a GBBF configuration), all of the components of beam manager 605 may be located in the ground network. In another example (e.g., corresponding to an OBBF configuration), the beamformer 645 may be located in the satellite network (e.g., in one or more of the satellites) and the rest of the components of beam manager 605 may each be located in either the ground network or the satellite network.

Antenna array 610 may be an example of the antennas of the satellite network 101 of FIG. 1, and may include antenna elements 615. In some examples, one or more of the antenna elements 615 may be or include an antenna panel. The spacing between antenna elements 615 may be evenly distributed across an aperture of antenna array 610, or the spacing of antenna elements 615 may be different across antenna array 610. In some examples, a first antenna array 610 may be included within the ground segment and a second antenna array 610 (e.g., one or more antenna arrays coupled with each other using transponders) may be included within the space segment.

Bus 625 may represent an interface over which signals may be exchanged between components of beam manager 605 and a location (e.g., a central location) that may be used to distribute the signals to the signal processing components of beam manager 605 (e.g., terminal tracker 620, beam signal processor 650, beamformer 645). Bus 625 may include one or more wired interfaces. Additionally, or alternatively, bus 625 may be a wireless interface that is used to wirelessly communicate signaling between the signal processing components—e.g., in accordance with a communication protocol. Beamformer 645 may be coupled with antenna elements 615 via one or more wired or wireless interfaces.

The memory 630 may include volatile memory (e.g., random access memory (RAM)) and/or non-volatile memory (e.g., read-only memory (ROM)). Other types of memory may also be possible. The memory 630 may store code 635 that is computer-readable and computer-executable. The code may include instructions that, when executed by processor 640, cause beam manager 605 to perform various functions described herein. The code 635 may be stored in a non-transitory computer-readable medium such as system memory or another type of memory. In some cases, the code 635 may not be directly executable by processor 640 but may cause a computer (e.g., when compiled and executed) to perform functions described herein. In some cases, the memory 630 may contain, among other things, a basic I/O system (BIOS) which may control basic hardware or software operation such as the interaction with peripheral components or devices.

Processor 640 may include an intelligent hardware device (e.g., a general-purpose processor), a digital signal processor (DSP), a central processing unit (CPU), a microcontroller, an application-specific integrated circuit (ASIC), a field programmable gate array (FPGA), a programmable logic device (PLD), a discrete gate or transistor logic component, a discrete hardware component, or any combination thereof. Processor 640 may be configured to execute computer-readable instructions stored in a memory (e.g., memory 630) to cause beam manager 605 to perform various functions (e.g., functions or tasks supporting mobile satellite beam deconfliction). For example, processor 640 and memory 630 may be configured to perform the various functions described herein.

Beam signal processor 650 may be configured to process (e.g., demodulate, decode) receive beam signals 654 received from beamformer 645. Beam signal processor 650 may decode data symbols included in the receive beam signals 654 to obtain receive beam data signals 664. Information (e.g., packets) in receive beam data signals 664 may be passed (e.g., via network(s) 125) to a destination device. Beam signal processor 650 may also be configured to process (e.g., encode, modulate) transmit beam data signals 662 to obtain transmit beam signals 652 to send to beamformer 645. Transmit beam data signals 662 may include information (e.g., packets) received (e.g., via network(s) 125) for transmission to terminals 120.

Terminal tracker 620 may be configured to determine information for beamformer 645 to use in forming beamformed spot beams (e.g., beamformed spot beams 150 of FIG. 1) using antenna elements 615. To determine the information for forming the beamformed spot beams, terminal tracker 620 may identify a set of terminals (e.g., mobile terminals 120 of FIG. 1) to be assigned as reference terminals, and may determine spatial information associated with the reference terminals. Terminal tracker 620 may determine a set of beamforming coefficients (e.g., phase shifts, amplitude components) that beamformer 645 may use to generate beamformed spot beams having individual coverage areas directed to the spatial information associated with the reference terminals.

Terminal tracker 620 may determine the beamforming coefficients to isolate signals transmitted over beamformed spot beams from one another—e.g., by, in each beamformed spot beam, emphasizing the signals transmitted within the beamformed spot beam and canceling interference from signals transmitted within other beamformed spot beams. The beamforming coefficients may be included in an M×N matrix, where a value of M may indicate the quantity of antennas and a value of N may indicate the quantity of spatial layers, where the value of N may be less than or equal to the value of M.

For transmission of beamformed spot beams via antenna elements 615, terminal tracker 620 may determine a single set of transmit beamforming coefficients for a frequency range or channel (e.g., a frequency channel 210 of FIG. 2B) and each of one or more time periods (e.g., time periods 215, time slots t of FIG. 2B), that is applied to a set of transmit beam signals 652 associated with the beamformed spot beams. Beamformer 645 may apply the set of transmit beamforming coefficients to the set of transmit beam signals 652 to obtain component signals 656 for transmission via antenna elements 615.

For reception of beamformed spot beams via antenna elements 615, terminal tracker 620 may determine a single set of receive beamforming coefficients for a frequency range or channel (e.g., a frequency channel 210 of FIG. 2B) and each of one or more time periods (e.g., time periods 215, time slots t of FIG. 2B), that may be applied to component signals 656 by beamformer 645 to obtain a set of receive beam signals 654 associated with the beamformed spot beams.

In some examples, the beamforming coefficients may be determined at the one or more satellites 105. In some examples, the beamforming coefficients may be received by the one or more satellites from one or more ground stations (e.g., network devices 130 or other stations of ground network 135) after terminal tracker 620 determines the beamforming coefficients.

In some examples, terminal tracker 620, beamformer 645, beam signal processor 650, or various combinations or components thereof, may be implemented in hardware (e.g., in communications management circuitry). The hardware may include a processor, a DSP, an ASIC, an FPGA or other PLD, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, terminal tracker 620, beamformer 645, beam signal processor 650, or various combinations or components thereof, may be implemented in code 635 (e.g., as communications management software or firmware), executed by processor 640. If implemented in code 635 executed by processor 640, the functions of terminal tracker 620, beamformer 645, beam signal processor 650, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

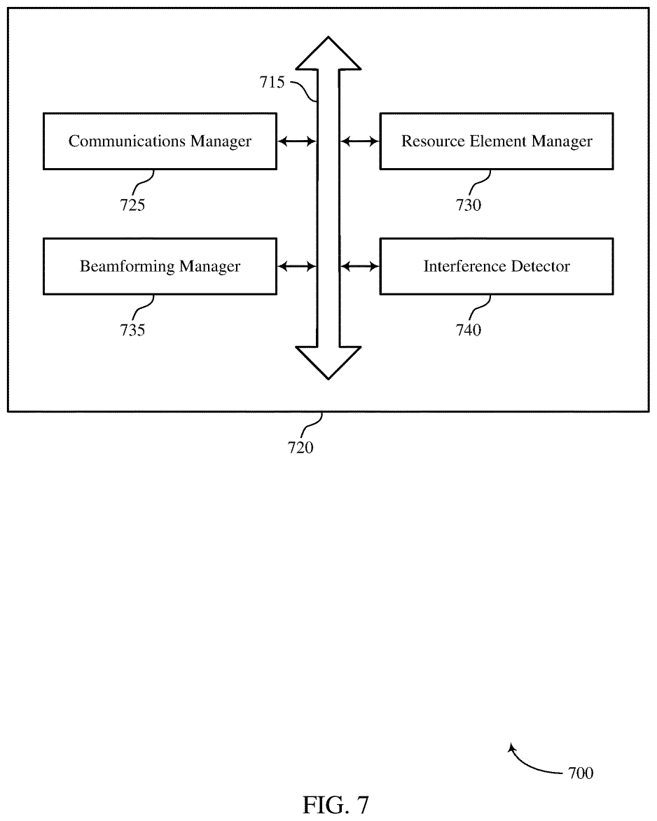

FIG. 7 shows a block diagram 700 of a terminal tracker 720 that supports per link mobile satellite beam deconfliction in accordance with examples as disclosed herein. Terminal tracker 720 may be an example of aspects of terminal tracker 620 as described with reference to FIG. 6. Terminal tracker 720, or various components thereof, may be an example of means for performing various aspects of per link mobile satellite beam deconfliction as described herein. For example, terminal tracker 720 may include a communications manager 725, a resource element manager 730, a beamforming manager 735, an interference detector 740, or any combination thereof. Each of these components may communicate, directly or indirectly, with one another (e.g., via one or more buses 715).

The communications manager 725 may be configured as or otherwise support a means for providing a communication service to a plurality of mobile terminals via a set of beamformed spot beams. In some examples, the communications manager 725 may be configured as or otherwise support a means for providing a communication service to a first mobile terminal and a second mobile terminal via a first beamformed spot beam and a second beamformed spot beam of a satellite communication system, as discussed herein. The first and second mobile terminals may be respectively assigned to the first and second beamformed spot beams. In some examples, the first and second beamformed spot beams may each include a forward link and a return link. In some examples, the communications manager 725 may comprise one or more of the other components of terminal tracker 720. In some examples, the communications manager 725 may comprise the resource element manager 730, the beamforming manager 735, and the beam coefficient determiner 740.

The resource element manager 730 may be configured as or otherwise support a means for assigning resource elements to forward and return links of beamformed spot beams. In some examples, the resource element manager 730 may be configured for assigning a same first resource element to the forward links of the first and second beamformed spot beams, and second and third resource elements respectively to the return links of the first and second beamformed spot beams, as discussed herein. The resource element manager 730 may also be configured as or otherwise support a means for assigning a same first resource element to the return links of the first and second beamformed spot beams and second and third resource elements respectively to the forward links of the first and second beamformed spot beams, as discussed herein. The second and third resource elements may be different from each other. The resource element manager 730 may be further configured as or otherwise support a means for assigning a fourth resource element to the forward link or the return link of the second beamformed spot beam in place of the first resource element. The fourth resource element may be different than the first resource element. The assigning of the fourth resource element may be based on an interference metric between the forward links that were assigned to the first resource element, or between the return links that were assigned to the first resource element.

In some examples, the same first resource element is assigned to the forward links of the first and second beamformed spot beams and the second and third resource elements are respectively assigned to the return links of the first and second beamformed spot beam beams; the interference metric between the forward links of the first and second beamformed spot beams is determined to satisfy the threshold value; and the fourth resource element is assigned to the forward link of the second beamformed spot beam.

In some examples, the same first resource element is assigned to the return links of the first and second beamformed spot beams and the second and third resource elements are respectively assigned to the forward links of the first and second beamformed spot beam beams; the interference metric between the return links of the first and second beamformed spot beams is determined to satisfy the threshold value; and the fourth resource element is assigned to the return link of the second beamformed spot beam.

The beamforming manager 735 may be configured as or otherwise support a means for adjusting respective coverage areas of beamformed spot beams to track movement of mobile terminals within a coverage area of a satellite communication system, as discussed herein.

The interference detector 740 may be configured as or otherwise support a means for determining that an interference metric between the forward links or the return links satisfies a threshold value. In some examples, the interference metric may be determined between the forward links to which a same resource element was assigned, or between the return links which a same resource element was assigned. In some examples, the same resource element is assigned to the forward links such that the interference metric between the forward links satisfies the threshold value. In some examples, the same resource element is assigned to the return links such that the interference metric between the return links satisfies the threshold value.

In some examples, aspects of one or more components of terminal tracker 720 or 620 may be found in other components of the terminal tracker or even outside of the terminal tracker. For example, processor 640 and memory 630 of beam manager 605 may be used in performing one or more functions associated with the components of terminal tracker 720.

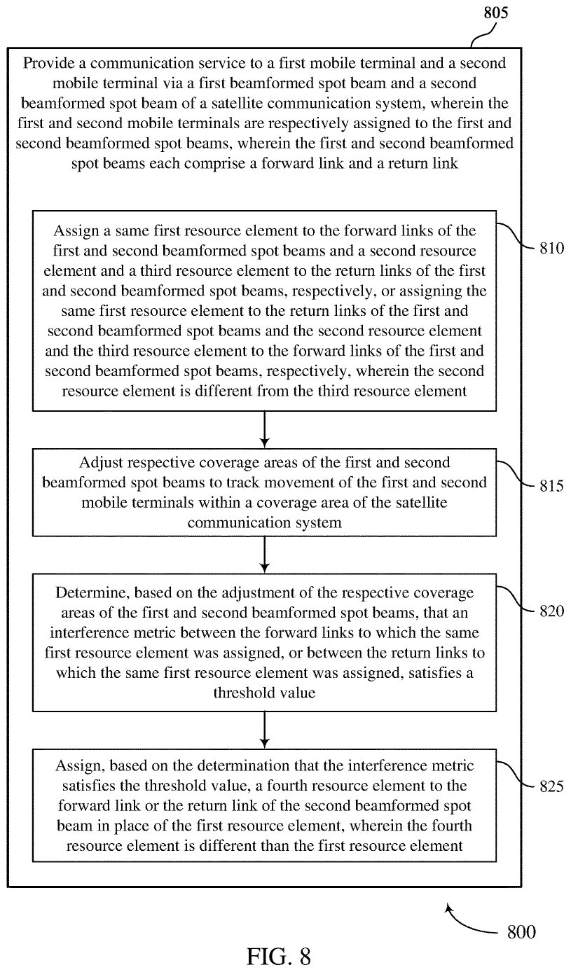

FIG. 8 shows a flowchart illustrating a method 800 that supports per link mobile satellite beam deconfliction in accordance with examples as disclosed herein. The operations of method 800 may be implemented by a satellite communication system or its components as described herein. For example, the operations of method 800 may be performed by a beam manager as described with reference to FIGS. 1 through 7. In some examples, a processor may execute a set of instructions to control the functional elements of the beam manager to perform the described functions. Additionally, or alternatively, the beam manager may perform aspects of the described functions using special-purpose hardware.

At 805, the method may include providing a communication service to a first mobile terminal and a second mobile terminal via a first beamformed spot beam and a second beamformed spot beam of a satellite communication system, wherein the first and second mobile terminals are respectively assigned to the first and second beamformed spot beams, wherein the first and second beamformed spot beams each comprise a forward link and a return link. The operations of 805 may be performed in accordance with examples as disclosed herein. In some examples, aspects of the operations of 805 may be performed by a communications manager 725 as described with reference to FIG. 7. In some examples, providing the communication service may include the operations of 810, 815, 820, and 825.

At 810, the method may include assigning a same first resource element to the forward links of the first and second beamformed spot beams and a second resource element and a third resource element to the return links of the first and second beamformed spot beams, respectively, or assigning the same first resource element to the return links of the first and second beamformed spot beams and the second resource element and the third resource element to the forward links of the first and second beamformed spot beams, respectively, wherein the second resource element is different from the third resource element. The operations of 810 may be performed in accordance with examples as disclosed herein. In some examples, aspects of the operations of 810 may be performed by a resource element manager 730 as described with reference to FIG. 7.

At 815, the method may include adjusting respective coverage areas of the first and second beamformed spot beams to track movement of the first and second mobile terminals within a coverage area of the satellite communication system. The operations of 820 may be performed in accordance with examples as disclosed herein. In some examples, aspects of the operations of 820 may be performed by a beamforming manager 735 as described with reference to FIG. 7.

At 820, the method may include determining, based on the adjustment of the respective coverage areas of the first and second beamformed spot beams, that an interference metric between the forward links to which the same first resource element was assigned, or between the return links to which the same first resource element was assigned, satisfies a threshold value. The operations of 825 may be performed in accordance with examples as disclosed herein. In some examples, aspects of the operations of 825 may be performed by an interference detector 740 as described with reference to FIG. 7.

At 825, the method may include assigning, based on the determination that the interference metric satisfies the threshold value, a fourth resource element to the forward link or the return link of the second beamformed spot beam in place of the first resource element, wherein then fourth resource element is different than the first resource element. The operations of 830 may be performed in accordance with examples as disclosed herein. In some examples, aspects of the operations of 830 may be performed by a resource element manager 730 as described with reference to FIG. 7.

In some examples, an apparatus as described herein may perform a method or methods, such as method 800. The apparatus may include features, circuitry, logic, means, or instructions (e.g., a non-transitory computer-readable medium storing instructions executable by a processor), or any combination thereof for performing the method or methods.

It should be noted that these methods describe examples of implementations, and that the operations and the steps may be rearranged or otherwise modified such that other implementations are possible. In some examples, aspects from two or more of the methods may be combined. For example, aspects of each of the methods may include steps or aspects of the other methods, or other steps or techniques described herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA, or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

Computer readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer readable media may include RAM, ROM, electrically erasable programmable read-only memory (EEPROM), flash memory, compact disk read-only memory (CDROM) or other optical disk storage, magnetic disk storage or other magnetic storage devices, or any other non-transitory medium that can be used to carry or store desired program code means in the form of instructions or data structures and that can be accessed by a general purpose or special purpose computer, or a general purpose or special purpose processor. Also, any connection is properly termed a computer readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu ray disc where disks usually reproduce data magnetically, while discs reproduce data optically with lasers. Combinations of the above are also included within the scope of computer readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

Please enter the following amendments to the claims:

1. A method, comprising:
providing a communication service to a first mobile terminal and a second mobile terminal via a first beamformed spot beam and a second beamformed spot beam of a satellite communication system, wherein the first and second mobile terminals are respectively assigned to the first and second beamformed spot beams, wherein the first and second beamformed spot beams each comprise a forward link and a return link, and wherein providing the communication service comprises:
assigning a same first resource element to the forward links of the first and second beamformed spot beams and a second resource element and a third resource element to the return links of the first and second beamformed spot beams, respectively, or assigning the same first resource element to the return links of the first and second beamformed spot beams and the second resource element and the third resource element to the forward links of the first and second beamformed spot beams, respectively, wherein the second resource element is different from the third resource element, and wherein each of the first, second, and third resource elements comprises a frequency resource and a time slot;
adjusting, based on measurements of signals communicated with the first and second mobile terminals, respective coverage areas of the first and second beamformed spot beams to track movement of the first and second mobile terminals within a coverage area of the satellite communication system;
determining, based on the adjustment of the respective coverage areas of the first and second beamformed spot beams, that an interference metric between the forward links to which the same first resource element was assigned, or between the return links to which the same first resource element was assigned, satisfies a threshold value; and
assigning, based on the determination that the interference metric satisfies the threshold value, a fourth resource element to the forward link or the return link of the second beamformed spot beam in place of the first resource element, wherein the fourth resource element is different than the first resource element.

2. The method of claim 1, wherein assigning the second and third resource elements is performed independent of assigning the same first resource element.

3. The method of claim 1, wherein providing the communication service further comprises:
maintaining the assignments of the second and third resource elements to the forward links of the first and second beamformed spot beams or the return links of the first and second beamformed spot beams during the assigning of the fourth resource element to the forward link or the return link of the second beamformed spot beam.

4. The method of claim 1, wherein:
the same first resource element is assigned to the forward links of the first and second beamformed spot beams and the second and third resource elements are assigned to the return links of the first and second beamformed spot beams, respectively;
the interference metric is determined to satisfy the threshold value between the forward links of the first and second beamformed spot beams; and
the fourth resource element is assigned to the forward link of the second beamformed spot beam.

5. The method of claim 1, wherein:
the same first resource element is assigned to the return links of the first and second beamformed spot beams and the second and third resource elements are assigned to the forward links of the first and second beamformed spot beams, respectively;
the interference metric is determined to satisfy the threshold value between the return links of the first and second beamformed spot beams; and
the fourth resource element is assigned to the return link of the second beamformed spot beam.

6. The method of claim 1, wherein the interference metric is based on one or more of:
a measured interference between the forward links of the first and second beamformed spot beams or the return links of the first and second beamformed spot beams,
an estimated interference between the forward links of the first and second beamformed spot beams or the return links of the first and second beamformed spot beams,
a correlation between channels of the first and second mobile terminals, or
a distance between the first and second mobile terminals.

7. A method, comprising:
providing a communication service to a first mobile terminal and a second mobile terminal via a first beamformed spot beam and a second beamformed spot beam of a satellite communication system, wherein the first and second mobile terminals are respectively assigned to the first and second beamformed spot beams, wherein the first and second beamformed spot beams each comprise a forward link and a return link, and wherein providing the communication service comprises:
assigning a same first resource element to the forward links of the first and second beamformed spot beams and a second resource element and a third resource element to the return links of the first and second beamformed spot beams, respectively, or assigning the same first resource element to the return links of the first and second beamformed spot beams and the second resource element and the third resource element to the forward links of the first and second beamformed spot beams, respectively, wherein the second resource element is different from the third resource element, and wherein each of the first, second, and third resource elements comprises a frequency resource and a time slot;
adjusting respective coverage areas of the first and second beamformed spot beams to track movement of the first and second mobile terminals within a coverage area of the satellite communication system;
determining, based on the adjustment of the respective coverage areas of the first and second beamformed spot beams, that an interference metric between the forward links to which the same first resource element was assigned, or between the return links to which the same first resource element was assigned, satisfies a threshold value, wherein the threshold value is based on respective beam widths of the first and second beamformed spot beams; and
assigning, based on the determination that the interference metric satisfies the threshold value, a fourth resource element to the forward link or the return link of the second beamformed spot beam in place of the first resource element, wherein the fourth resource element is different than the first resource element.

8. The method of claim 1, wherein assigning the fourth resource element to the forward link or the return link of the second beamformed spot beam comprises:
changing at least one of: a frequency resource associated with the forward link or the return link of the second beamformed spot beam, a time slot associated with the forward link or the return link of the second beamformed spot beam, a polarization associated with the forward link or the return link of the second beamformed spot beam, or one or more codes associated with the forward link or the return link of the second beamformed spot beam.

9. (canceled)

10. (canceled)

11. The method of claim 1, wherein each of the first, second, and third resource elements comprises a polarization.

12. A system for satellite communications, comprising:
one or more satellites; and
a beam manager configured to:
provide a communication service to a first mobile terminal and a second mobile terminal via a first beamformed spot beam and a second beamformed spot beam of the one or more satellites, wherein the first and second mobile terminals are respectively assigned to the first and second beamformed spot beams, wherein the first and second beamformed spot beams each comprises a forward link and a return link, and wherein to provide the communication service, the beam manager is configured to:
assign a same first resource element to the forward links of the first and second beamformed spot beams and a second resource element and a third resource element to the return links of the first and second beamformed spot beams, respectively, or assign the same first resource element to the return links of the first and second beamformed spot beams and the second resource element and the third resource element to the forward links of the first and second beamformed spot beams, respectively, wherein the second resource element is different from the third resource element, and wherein each of the first, second, and third resource elements comprises a frequency resource and a time slot;
adjust, based on measurements of signals communicated with the first and second mobile terminals, respective coverage areas of the first and second beamformed spot beams to track movement of the first and second mobile terminals within a coverage area of a satellite communication system;
determine, based on the adjustment of the respective coverage areas of the first and second beamformed spot beams, that an interference metric between the forward links to which the same first resource element was assigned, or between the return links to which the same first resource element was assigned, satisfies a threshold value; and
assign, based on the determination that the interference metric satisfies the threshold value, a fourth resource element to the forward link or the return link of the second beamformed spot beam in place of the first resource element, wherein the fourth resource element is different than the first resource element.

13. The system of claim 12, further comprising:
a ground station configured to communicate with the one or more satellites via one or more satellite beams.

14. The system of claim 13, wherein the ground station comprises a network device or a gateway.

15. The system of claim 12, wherein the beam manager is configured to:
assign the second and third resource elements independent of assigning the same first resource element.

16. The system of claim 12, wherein to provide the communication service, the beam manager is further configured to:
maintain the assignments of the second and third resource elements to the forward links of the first and second beamformed spot beams or the return links of the first and second beamformed spot beams during the assigning of the fourth resource element to the forward link or the return link of the second beamformed spot beam.

17. The system of claim 12, wherein:
the same first resource element is assigned to the forward links of the first and second beamformed spot beams and the second and third resource elements are assigned to the return links of the first and of the first and second beamformed spot beams, respectively;
the interference metric is determined to satisfy the threshold value between the forward links of the first and second beamformed spot beams, and
the fourth resource element is assigned to the forward link of the second beamformed spot beam.

18. The system of claim 12, wherein:
the same first resource element is assigned to the return links of the first and second beamformed spot beams and the second and third resource elements are assigned to the forward links of the first and second beamformed spot beams, respectively;
the interference metric is determined to satisfy the threshold value between the return links of the first and second beamformed spot beams; and
the fourth resource element is assigned to the return link of the second beamformed spot beam.

19. The system of claim 12, wherein the interference metric is based on one or more of:
a measured interference between the forward links of the first and second beamformed spot beams or the return links of the first and second beamformed spot beams,
an estimated interference between the forward links of the first and second beamformed spot beams or the return links of the first and second beamformed spot beams,
a correlation between channels of the first and second mobile terminals, or
a distance between the first and second mobile terminals.

20. A system for satellite communications, comprising:
one or more satellites; and
a beam manager configured to:
provide a communication service to a first mobile terminal and a second mobile terminal via a first beamformed spot beam and a second beamformed spot beam of the one or more satellites, wherein the first and second mobile terminals are respectively assigned to the first and second beamformed spot beams, wherein the first and second beamformed spot beams each comprises a forward link and a return link, and wherein to provide the communication service, the beam manager is configured to:
assign a same first resource element to the forward links of the first and second beamformed spot beams and a second resource element and a third resource element to the return links of the first and second beamformed spot beams, respectively, or assigning the same first resource element to the return links of the first and second beamformed spot beams and the second resource element and the third resource element to the forward links of the first and second beamformed spot beams, respectively, wherein the second resource element is different from the third resource element, and wherein each of the first, second, and third resource elements comprises a frequency resource and a time slot;
adjust respective coverage areas of the first and second beamformed spot beams to track movement of the first and second mobile terminals within a coverage area of a satellite communication system;
determine, based on the adjustment of the respective coverage areas of the first and second beamformed spot beams, that an interference metric between the forward links to which the same first resource element was assigned, or between the return links to which the same first resource element was assigned, satisfies a threshold value, wherein the threshold value is based on respective beam widths of the first and second beamformed spot beams; and
assign, based on the determination that the interference metric satisfies the threshold value, a fourth resource element to the forward link or the return link of the second beamformed spot beam in place of the first resource element, wherein the fourth resource element is different than the first resource element.

21. The system of claim 12, wherein to assign the fourth resource element to the forward link or the return link of the second beamformed spot beam, the beam manager is further configured to:
change at least one of: a frequency resource associated with the forward link or the return link of the second beamformed spot beam, a time slot associated with the forward link or the return link of the second beamformed spot beam, a polarization associated with the forward link or the return link of the second beamformed spot beam, or one or more codes associated with the forward link or the return link of the second beamformed spot beam.

22. (canceled)

23. (canceled)

24. The system of claim 12, wherein each of the first, second, and third resource elements comprises a polarization.

25. The method of claim 1, further comprising:
determining to assign the fourth resource element to the forward link or the return link of the second beamformed spot beam based on a priority of the second mobile terminal being less than a priority of the first mobile terminal or based on a demand of the second mobile terminal being less than a demand of the first mobile terminal.

26. The method of claim 1, further comprising:
determining, based on assigning the fourth resource element to the forward link or the return link of the second beamformed spot beam, that the interference metric between the forward links of the first and second beamformed spot beams, or between the return links of the first and second beamformed spot beams, fails to satisfy a second threshold value that is different than the threshold value; and
assigning, based on the determination that the interference metric fails to satisfy the second threshold value, the first resource element to the forward link or the return link of the second beamformed spot beam in place of the fourth resource element.

27. The system of claim 12, wherein the beam manager is configured to:
determine to assign the fourth resource element to the forward link or the return link of the second beamformed spot beam based at least in part on a priority of the second mobile terminal being less than a priority of the first mobile terminal or based at least in part on a demand of the second mobile terminal being less than a demand of the first mobile terminal.

28. The system of claim 12, wherein the beam manager is configured to:
determine, based on assigning the fourth resource element to the forward link or the return link of the second beamformed spot beam, that the interference metric between the forward links of the first and second beamformed spot beams, or between the return links of the first and second beamformed spot beams, fails to satisfy a second threshold value that is different than the threshold value; and
assign, based on the determination that the interference metric fails to satisfy the second threshold value, the first resource element to the forward link or the return link of the second beamformed spot beam in place of the fourth resource element.
